(19) United States
(12) Patent Application Publication
(10) Pub. No.: US 2008/0112049 A1
(43) Pub. Date: May 15, 2008

(54) POLARIZER, POLARIZING PLATE, CIRCULAR POLARIZING FILTER, IMAGE DISPLAY SYSTEM, AND METHOD OF PRODUCING POLARIZER

(75) Inventors: Tooru UMEMOTO, Ibaraki-shi (JP); Seiji UMEMOTO, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/926,887

(22) Filed: Oct. 29, 2007

(30) Foreign Application Priority Data
Nov. 9, 2006 (JP) 2006-303463

(51) Int. Cl. G02B 5/30; B29D 11/00

(52) U.S. Cl. 359/491; 264/1.34

(57) ABSTRACT

A polarizer of the present invention is characterized by containing at least one species of a photochromic dye in a resin. Preferably, the photochromic dye is used as a dichroic dye and aligned in one direction in the resin. A circular polarizing filter of the present invention has the polarizer and a retardation plate.

In the polarizer of the present invention, the photochromic dye is colored by ultraviolet light irradiation and discolored by visible light irradiation or heat after being colored. By this photochromic property, the polarizer takes out linearly polarized light in being used in an environment of intense ultraviolet light, and on the other hand, the polarizer transmits light in an environment of weak ultraviolet light.

### BACKGROUND OF THE INVENTION

1. Field of the Invention

The present invention relates to a photochromic polarizer containing a photochromic dye, a polarizing plate, a polarizing filter and an image display system including the polarizer, and a method of producing a polarizer.

2. Description of the Related Art

When an image display system is used in an environment of intense outside light such as outdoors, the outside light is reflected on a screen to cause significant screen visibility degradation. In order to solve this problem, there is means for performing an anti-glare treatment on the surface of the screen. By this means, the reduction in the visibility resulting from the outside light impinging on and reflected by the surface of the screen can be prevented to some extent. But, by this means, it is not possible to prevent the outside light incident from the screen into the display system from impinging/being reflected on various constituent members and exiting from the screen. For example, in the case of an image display system (hereinafter, referred to as an organic EL display system) having an organic electroluminescence (EL) device, the outside light tends to be reflected by a reflective metal electrode provided in the display system. Therefore, in the organic EL display system, the reduction in the visibility resulting from the outside light particularly becomes a problem.

Accordingly, in order to reduce the reflection of the outside light, organic EL display systems provided with a circular polarizing filter are proposed in Japanese Unexamined Patent Publication No. 8-321381 and Japanese Unexamined Patent Publication No. 9-127885.

Specifically, this circular polarizing filter has a polarizer taking out linearly polarized light and a quarter-wave plate, a slow axis of which is located at about 45° angle with respect to an absorbing axis of the polarizer. The circular polarizing filter is provided on the surface of the screen with the quarter-wave plate toward the screen. A part of the outside light impinged on the circular polarizing filter is absorbed by the polarizer, and a part of the light is transmitted through the polarizer as linearly polarized light. The linearly polarized light is converted to circularly polarized light by the quarter-wave plate. The circularly polarized light is reflected by a reflective metal electrode or the like in the organic EL device to become laterally-reversed circularly polarized light and the resulting polarized light enters the quarter-wave plate again. The resulting laterally-reversed circularly polarized light cannot transmit through the polarizer since it is converted to the linearly polarized light, a polarization plane of which is orthogonal to a direction of a transmission axis of the polarizer after entering the quarter-wave plate. By such a principle, the reduction in the visibility resulting from the reflection of the outside light can be prevented.

However, in the above-mentioned method of using the circular polarizing filter, the polarizer absorbs the light (hereinafter, referred to as emitted light for display) emitted by the display system itself such as an organic EL device. Therefore, since about half of the emitted light for display is absorbed by the polarizer, a problem that screen display becomes dark arises when the image display system is used in an environment of weak outside light such as an indoor area.

If the circular polarizing filter is removed, this problem is resolved, but if doing so, the above-mentioned problem that in an environment of intense outside light such as outdoors, the outside light is reflected and the screen visibility is significantly deteriorated cannot be solved.

### SUMMARY OF THE INVENTION

It is an object of the present invention to provide a polarizer which can exhibit polarization properties (property of transmitting only linearly polarized light in a certain vibration direction) in being used in an environment of intense ultraviolet light and can prevent the absorption of the emitted light for display in an environment of weak ultraviolet light.

Further, it is an object of the present invention to provide a circular polarizing filter which can prevent the reflection of the outside light in being used in an environment of intense ultraviolet light and can prevent the absorption of the emitted light for display in being used in an environment of weak ultraviolet light.

Further, it is an object of the present invention to provide a method of producing the above-mentioned polarizer.

The present inventors made earnest investigations concerning an ideal novel material which absorbs light in an environment of intense outside light and does not absorb light in an environment of weak outside light, and consequently have noted a photochromic dye. The photochromic dye changes into a colored state by ultraviolet light irradiation. On the other hand, this dye returns to a discolored state, for example, when the ultraviolet light irradiation becomes weak and visible light is irradiated. The present inventors found that the above-mentioned problems can be solved by using this reversibility of the photochromic dye exclusively.

The present invention provides a polarizer containing at least one species of a photochromic dye in a resin.

Since the above-mentioned polarizer contains a photochromic dye, it changes into a colored state by ultraviolet light irradiation and develops polarization properties. On the other hand, this polarizer returns to a discolored state, for example, when the ultraviolet light irradiation becomes weak and visible light irradiation becomes intense. Accordingly, this polarizer exhibits polarization properties in outside light (outdoors etc.) including a large quantity of ultraviolet light and loses polarization properties in outside light (indoors etc.) including a small quantity of ultraviolet light.

The above-mentioned polarizer preferably uses the above-mentioned photochromic dye as a dichroic dye.

The above-mentioned any polarizer is preferably such that the photochromic dye is aligned in one direction.

The above-mentioned any polarizer is preferably such that the photochromic dye exhibits a photochromic property in which the dye is colored by ultraviolet light irradiation and discolored by visible light irradiation or heat after being colored.

The above-mentioned any polarizer can be preferably obtained by forming a resin composition containing the photochromic dye and a resin into a film and stretching the film.

The above-mentioned any polarizer does not preferably contain an ultraviolet absorber.

The present invention provides a polarizing plate in which a protective layer is laminated on one side or both sides of the above-mentioned any polarizer.

The protective layer preferably have substantially no ultraviolet light absorption power.

The present invention provides a circular polarizing filter in which at least one species of retardation plates is laminated on the above-mentioned any polarizer.

The circular polarizing filter is preferably such that the protective layer is laminated on one side or both sides of the polarizer.

As described above, the polarizer of the present invention exhibits polarization properties in outside light (outdoors etc.) including a large quantity of ultraviolet light and loses polarization properties in outside light (indoors etc.) including a small quantity of ultraviolet light. The circular polarizing filter provided with such the polarizer can prevent the reflection of the outside light in the outside light such as outdoors. On the other hand, the circular polarizing filter transmits the emitted light for display from the inside of the system well and can realize bright screen display in the outside light such as an indoor area.

The present invention provides an image display system, wherein the circular polarizing filter is provided on an image display surface with the retardation plate of the circular polarizing filter toward the image display surface.

The image display system is preferably an organic EL display system having an organic EL device.

The present invention provides a method of producing a polarizer, wherein a photochromic dye is aligned in one direction by stretching a resin film containing the photochromic dye. The resin film containing a photochromic dye is preferably prepared by casting a resin solution formed by dissolving at least a resin and a photochromic dye in an solvent on a substrate. The resin film is preferably stretched in a condition of heating.

The resin film containing a photochromic dye is preferably prepared by swelling a resin film and Immersing the swelled film in a solution containing a photochromic dye. The resin film is preferably stretched in a liquid.

### BRIEF DESCRIPTION OF THE DRAWINGS

FIGS. 1A and 1B are partially omitted longitudinal sectional views showing an embodiment of a circular polarizing filter of the present invention;

FIGS. 2A and 2B are partially omitted longitudinal sectional views showing an image display system including the circular polarizing filter of the present invention;

FIG. 3 is a graph of absorbance spectrums of a polarizer prepared in Example before and after ultraviolet light irradiation;

FIG. 4 is a graph of k₁ and k₂ spectrums of the polarizer prepared in Example before ultraviolet light irradiation; and

FIG. 5 is a graph of k₁ and k₂ spectrums of the polarizer prepared in Example after ultraviolet light irradiation.

### DETAILED DESCRIPTION OF THE PREFERRED EMBODIMENT

Hereinafter, the embodiments of the present invention will be described.

### <Polarizer>

A polarizer of the present invention contains a photochromic dye in a resin. In the polarizer of the present invention, the photochromic dye is dispersed in a resin film and aligned in one direction.

As the resin film, a transparent and colorless film is used and a film having a linear polymer as the main component is preferably used. Incidentally, the linear polymer is a polymer having a main chain of a long chain, and includes a polymer partially having a branched chain on the main chain.

As a resin of the above-mentioned resin film, vinyl alcohol polymers such as polyvinyl alcohol, modified polyvinyl alcohol and the like; vinyl acetate polymers; cellulose polymers such as diacetyl cellulose, triacetyl cellulose and the like; vinyl butyral polymers; halogenated vinyl polymers such as polyvinyl halide like vinyl chloride, polyvinylidene halide like vinylidene chloride and the like; polyester polymers such as polyethylene terephthalate, polyethylene naphthalate and the like; carbonate polymers; acrylic polymers such as polymethyl methacrylate and the like; styrene polymers such as polystyrene, acrylonitrile-styrene copolymer (AS resin) and the like; amide polymers such as nylon and the like; and olefinic polymers such as polyethylene, polypropylene, polyolefins having a cyclo structure or a norbornene structure, ethylene-propylene copolymer and the like; and the like can be exemplified. These polymers may be crosslinked as required.

Further, the transparent and colorless resin film refers to a film having a visible light (wavelength 450 nm to 650 nm) transmittance of 70% or more. In addition, a value of this light transmittance was measured at a film thickness of 100 μm with a spectrophotometer (manufactured by Hitachi, Ltd., trade name: Spectrophotometer Model U-4100)

As the photochromic dye used in the present invention, a dye having a property (photochromic property), in which the dye changes into a colored state by ultraviolet light irradiation and returns to a discolored state by visible light irradiation or heat after being colored, is preferred. The dye having such a photochromic property can be used without limit. As the photochromic dye, spiropyran compounds, spirooxazine compounds, diarylethene compounds, fulgide compounds, naphthopyran compounds and the like can be exemplified. These compounds can be used alone or in combination of two or more species.

As the above-mentioned spiropyran dye,
1,3,3-trimethylindolino-6′-nitrobenzopyrylospiran, 1′,3′,3′-trimethylspiro(2H-1-benzopyran-2,2′-indoline), 1′,3′,3′-trimethylspiro-8-nitro(2H-1-benzopyran-2,2′-indoline), 1′,3′,3′-trimethyl-6-hydroxyspiro(2H-1-benzopyran-2,2′-indoline), 1′,3′,3′-trimethylspiro-8-methoxy(2H-1-benzopyran-2,2′-indoline), 5′-chloro-1′,3′,3′-trimethyl-6-nitrospiro(2H-1-benzopyran-2,2′-indoline), 6,8-dibromo-1′,3′,3′-trimethylspiro(2H-1-benzopyran-2,2′-indoline), 6,8-dibromo-1′,3′,3′-trimethylspiro(2H-1-benzopyran-2,2′-indoline), 8-ethoxy-1′,3′,3′, 4″, 7-pentamethylspiro(2H-1-benzopyran-2,2′-indoline), 5′-chloro-1′,3′,3′-trimethylspiro-6,8-dinitro(2H-1-benzopyran-2,2′-indoline), 3,3,1-diphenyl-3H-naphtho-(2, 1-13)pyran, 1,3,3-triphenylspiro[indoline-2,3′-(3H)-naphtho(2,1-b)pyran], 1-(2,3,4,5,6-pentamethylbenzyl)-3,3-dimethylspiro[indoline-2,3′-(3H)-naphtho(2,1-b)pyran], 1-(2-methoxy-5-nitrobenzyl)-3,3-dimethylspiro[indoline-2,3′-naphtho(2,1-b)pyran], 1-(2-nitrobenzyl)-3,3-dimethylspiro[indoline-2,3′-naphtho(2,1-b)pyran], 1-(2-naphtylmethyl)-3,3-dimethylspiro[indoline-2,3′-naphtho(2,1-b)pyran], 1,3,3-trimethyl-6′-nitro-spiro(2H-1-benzopyran-2,2′-(2H)-indole) and the like can be exemplified,

As the above-mentioned spirooxazine dye,
1,3,3-trimethylspiro[indolino-2,3′-(3H)naphtho(2,1-b)(1, 4)oxazine], 5-methoxy-1,3,3-trimethylspiro[indolino-2,3′-(3H)naphtho(2,1-b) (1,4)oxazine], 5-chloro-1,3,3-trimethylspiro[indolino-2,3′-(3H)naphtho(2,1-b)(1,4)oxazine], 4,7-diethoxy-1,3,3-trimethylspiro[indolino-2,3′-(3H)naphtho(2,1-b)(1,4)oxazine], 5-chloro-1-butyl-3,3-dimethylspiro[indolino-2,3′-(3H)naphtho(2,1-b)(1, 4)oxazine], 1,3,3,5-tetramethyl-9′-ethoxyspiro[indolino-2,3′-(3H)naphtho(2,1-b)(1, 4)oxazine], 1-benzyl-3,3-dimethylspiro[indoline-2,3′-(3H)naphtho(2,1-b) (1,4)oxazine], 1-(4-methoxybenzyl)-3,3-dimethylspiro[indoline-2,3′-(3H)naphtho(2,1-b)(1,4)oxazine], 1-(2-methylbenzyl)-3,3-dimethylspiro[indoline-2,3′-(3H)naphtho(2,1-b)(1, 4)oxazine], 1-(3,5-dimethylbenzyl)-3,3-dimethylspiro[indoline-2,3′-(3H)naphtho(2,1-b)(1,4)oxazine], 1-(4-chlorobenzyl)-3,3-dimethylspiro[indoline-2,3′-(3H)naphtho(2,1-b)(1,4)oxazine] and the like can be exemplified.

As the above-mentioned diarylethene dye,
1,2-bis(2-phenyl-4-trifluoromethylthiazole)-3,3,4,4,5,5-hexafluorocyclopentene, 1,2-bis(3-(2-methyl-6-(2-(4-methoxyphenyl)ethinyl)benzothienyl))-3,3,4,4,5,5-hexafluorocyclopentene, 1,2-bis(5-methyl-2-phenylthiazole)-3,3,4,4,5,5-hexafluorocyclopentene, 1,2-bis(2-methoxy-5-phenyl-3-thienyl)-3,3,4,4,5,5-hexafluorocyclopentene, 1-(5-methoxy-1,2-dimethyl-3-indolyl)-2-(5-cyano-2,4-dimethyl-3-thienyl)-3,3, 4,4,5,5-hexafluorocyclopentene and the like can be exemplified.

As the above-mentioned fulgide dye,
N-cyanomethyl-6,7-dihydro-4-methyl-2-phenylspiro(5,6-benzo[b]thiophenedicarboxylmide-7,2′-tricyclo[3.3.1.1^{3,7}]decane), N-cyanomethyl-6,7-dihydro-2-(p-methoxyphenyl)-4-methylspiro(5,6-benzo[b]thiophenedicarboxylmide-7,2′-tricyclo[3.3.1.1^{3,7}]decane), 6,7-dihydro-N-methoxycarbonylmethyl-4-methyl-2-phenylspiro(5,6-benzo[b]thiophenedicarboxylmide-7,2′-tricyclo[3.3.1.1^{3,7}]decane), 6,7-dihydro-4-methyl-2-(p-methylphenyl)-N-nitromethylspiro(5,6-benzo[b]thiophenedicarboxyimide-7,2′-tricyclo[3.3.1.1^{3,7}]decane), N-cyanomethyl-6,7-dihydro-4-cyclopropyl-3-methylspiro(5,6-benzo[b]thiophenedicarboxylmide-7,2′-tricyclo[3.3.1.1^{3,7}]decane) and the like can be exemplified.

As the above-mentioned naphthopyran dye,
3,3-diphenyl-3H-naphtho(2,1-b)pyran, 2,2-diphenyl-2H-naphtho(1,2-b)pyran, 3-(2-fluorophenyl)-3-(4-methoxyphenyl)-3H-naphtho(2,1-b)pyran, 3-(2-methyl-4-methoxyphenyl)-3-(4-ethoxyphenyl)-3H-naphtho(2,1-b)pyran, 3-(2-furyl)-3-(2-fluorophenyl)-3H-naphtho(2,1-b)pyran, 3-(2-thienyl)-3-(2-fluoro-4-methoxyphenyl)-3H-naphtho(2,1-b)pyran, 3-[2-(1-methylpyrrolyl)]-3-(2-methyl-4-methoxyphenyl)-3H-naphtho(2,1-b)pyran, spiro[b]cyclo[3.3.1)nonane-9,3′-3H-naphtho(2,1-b)pyran], spiro[b]cyclo[3.3.1)nonane-9-2′-3H-naphtho(2,1-b)pyran] and the like can be exemplified.

Preferably, the above-mentioned photochromic dye is almost evenly dispersed in a resin film and almost of the dye is aligned in one direction to realize good dichroism.

Means for aligning the photochromic dye is not particularly limited. A simple method of the means for aligning is stretching the resin film containing the photochromic dye.

The above-mentioned photochromic dye is preferably a compound having a long chain structure in which length and width are different from each other in terms of a molecular structure. The photochromic dye is more preferably a compound in which π conjugation such as a benzene ring and a heterocycle is spread and a steric structure of constituent skeletons linked by the π conjugation does not change (however, the steric structure can be changed when the photochromic dye is changed to a colored state or a discolored state). The reason for this is that such the photochromic dye is easy to be aligned (superior in an aligning property) in one direction in a resin film containing this dye by stretching the resin film.

The content of the above-mentioned photochromic dye is preferably 0.1 to 10 parts by mass with respect to 100 parts by mass of a resin, more preferably 0.3 to 5.0 parts by mass, and particularly preferably 0.4 to 2.0 parts by mass.

Further, various additives such as a stabilizer, an antioxidant, an antistatic agent and a plasticizer may be added to the polarizer of the present invention as required. However, preferably, an ultraviolet absorber such as benzophenone compounds, benzotriazole compounds and benzoate compounds is not added. The reason for this is that if the polarizer of the present invention contains the ultraviolet absorber, there is a possibility that ultraviolet light irradiated to the polarizer is absorbed by the polarizer and the photochromic dye is not colored.

In addition, this ultraviolet absorber includes agents which are referred to as an ultraviolet shielding agent.

A thickness of the polarizer of the present invention is not particularly limited. Generally, the thickness of the polarizer is preferably about 10 to 100 μm, and more preferably about 50 to 100 μm.

The above-mentioned photochromic dye changes into a colored state in ultraviolet light included in solar light or ultraviolet light from various lamps such as an ultraviolet lamp, a mercury lamp, a xenon lamp and the like. The changes of the photochromic dye into the colored state proceeds by irradiating, for example, ultraviolet light with a wavelength of 250 to 400 nm to the polarizer. Therefore, the photochromic dye changes into a colored state and the polarizer is colored by solar light irradiation in the outdoors etc. The polarizer in a colored state exhibits good dichroism. The polarizer in a colored state has a function of transmitting only linearly polarized light in a certain vibration direction when natural light or polarized light enters.

A single transmittance of the polarizer in a colored state is preferably about 10% to 50%. A polarization degree of the polarizer in a colored state is preferably about 20% to 99%.

Incidentally, the single transmittance is measured according to JIS Z 8701-1995. The polarization degree is measured by a method described in the following Example.

Further, an absorbance of the polarizer in a colored state varies among species of the photochromic dye to be used. The absorbance at the maximum absorption wavelength (λₘₐₓ) of the photochromic dye is preferably 0.3 to 0.4. The absorbance is measured by a method described in the following Example.

On the other hand, if visible light is irradiated to or heat is added to the above-mentioned polarizer in a colored state, the photochromic dye is discolored. The coloring and the discoloration of the photochromic dye are reversible reactions. Therefore, when an effect of the ultraviolet light is large, the photochromic dye is colored. On the other hand, when an effect of visible light and/or a thermal effect is larger than that of ultraviolet light, the photochromic dye is discolored. Accordingly, in the polarizer of the present invention, when there is little ultraviolet light irradiated or a quantity of ultraviolet light irradiation is small and a quantity of visible light irradiation becomes relatively large, the photochromic dye is discolored, and therefore the polarization properties are lost. Or, in the polarizer of the present invention, the photochromic dye is discolored and the polarization properties are lost when there is little ultraviolet light irradiated or a quantity of ultraviolet light irradiation is small and a temperature is about room temperature (about 25° C.).

Accordingly, the polarizer of the present invention becomes a transparent film not exhibiting polarization properties in an environment in which there is little ultraviolet light irradiation or a little ultraviolet light irradiation such as an indoor area. The film not exhibiting polarization properties does not have the function of transmitting only linearly polarized light when natural light or polarized light enters.

In addition, the absorbance (at the above-mentioned maximum absorption wavelength (λₘₐₓ)) of the polarizer in a discolored state is 0.05 or less, and this polarizer in a discolored state hardly exhibits a light absorption power in the visible light region.

### <Production Method of Polarizer>

The polarizer of the present invention can be produced, for example, by a method of (a) forming a resin composition containing the photochromic dye and a resin into a film and stretching the film, or (b) immersing a resin film in a solution containing the photochromic dye and stretching the film.

By subjecting a resin film to a stretching treatment, the photochromic dye can be aligned, and in addition to this, a uniform polarizer without wrinkles can be obtained. And, by such a method, the polarizer of the present invention, in which the coloring and the discoloration are repeated reversibly in an environment of a normal use, can be obtained.

Examples of the above-mentioned production method (a) include a cast method.

Specifically, a solution formed by dissolving at least a resin and a photochromic dye in an appropriate solvent such as an organic solvent or water is casted on a substrate. By drying the resulting film on the substrate, a resin film containing the photochromic dye dispersed in a resin matrix can be prepared. By stretching the resulting resin film in a uniaxial direction, the photochromic dye can be aligned in one direction (stretching direction) to obtain the polarizer of the present invention. A thickness of an unstretched resin film is appropriately set in consideration of the thickness, the stretching strength of the polarizer to be obtained, and the like. The thickness of an unstretched resin film is preferably about 40 to 150 μm. An amount of the photochromic dye to be added is preferably 0.1 to 10 parts by mass with respect to 100 parts by mass of a resin, more preferably 0.3 to 5.0 parts by mass, and particularly preferably 0.4 to 2.0 parts by mass.

A stretching treatment may be a wet stretching process or a dry stretching process. The wet stretching process is such that a resin film is stretched in a liquid and the dry stretching process is such that a resin film is stretched in air. In the case of the wet stretching process, stretching is preferably performed at a liquid temperature of about 40° C. to 70° C. In the case of the dry stretching process, stretching is preferably performed in an atmosphere of about 50° C. to 200° C. A stretch ratio is about 3 to 10.

Further, in the above-mentioned production method (a), the cast method is exemplified as a method of forming a film, but the resin film containing the photochromic dye can also be prepared by publicly known methods of forming a film (for example, melt extrusion method) other than the cast method.

On the other hand, examples of the above-mentioned production method (b) include a method in which a swelled hydrophilic polymer film is immersed in a solution containing the photochromic dye to dye the film and the dyed film is stretched. This method can be performed according to a production method of a polarizer made of a polyvinyl alcohol film, which is dyed with iodine. That is, this method can be performed by replacing the above-mentioned iodine with the photochromic dye in the above-mentioned production method.

Specifically, the polarizer of the present invention can be produced undergoing the following swelling step, dyeing step, and stretching step.

The above-mentioned hydrophilic polymer film is not particularly limited, and as the hydrophilic polymer film, polyvinyl alcohol (hereinafter, referred to as PVA) films, partially formalized PVA films, modified PVA films, polyethylene terephthalate, an ethylene-vinyl acetate copolymer film, and partially saponified films thereof can be exemplified. Among others, PVA polymer films are preferred. When the PVA polymers are used, a saponification degree of the PVA is, for example, preferably 80 mol % to 100 mol %, and particularly more preferably 90 mol % to 100 mol % (according to JIS K 6726-1994). An average polymerization degree of the PVA is preferably 1000 to 10000, more preferably 1000 to 8000, and particularly preferably 1500 to 5000 (This average polymerization degree is a value according to JIS K 6726-1994). The above-mentioned hydrophilic polymer film can be produced by publicly known methods of forming a film such as a cast method and a melt extrusion method.

This hydrophilic polymer film is immersed in a swelling bath to swell the film (a swelling step).

As a solution of the swelling bath, water is generally used, but other substances may be added to water. And, a liquid temperature of the swelling bath is generally about 20° C. to 50° C., and preferably about 30° C. to 40° C. An immersing time of the film in the swelling bath is generally about 1 to 7 minutes.

The swelled hydrophilic polymer film is immersed in a dyeing bath to impregnate the hydrophilic polymer film with the photochromic dye (a dyeing step).

As a solution of the dyeing bath, a dyeing solution formed by dissolving or dispersing the above-mentioned photochromic dye in a solvent is used. As this solvent, water is generally used, but an organic solvent compatible with water may be added to water.

The concentration of the photochromic dye is not particularly limited. However, in order to produce the above-mentioned polarizer in which the photochromic dye is contained in an amount of 0.1 to 10 parts by mass with respect to 100 parts by mass of a resin, it is preferred that in a dyeing solution, the photochromic dye is mixed in the proportion of 0.0001 to 1 parts by mass with respect to 100 parts by mass of a solvent.

As the photochromic dye, one species of the photochromic dye may be used, or two or more species of the photochromic dyes may be used in combination. A water-soluble photochromic dye is preferably used.

Further, a dyeing aid may be added to the dyeing solution in order to efficiently impregnate a film with the photochromic dye.

Examples of the dyeing aid include urea and Glauber's salt (Na₂SO₄.10H₂O). An amount of the dyeing aid is preferably about 0.1 to 10 parts by mass with respect to 100 parts by mass of a solvent of the dyeing solution.

An immersing time of the film in the dyeing bath is not particularly limited, but it is preferably about 20 seconds to 1800 seconds. And, a liquid temperature of the dyeing bath is preferably about 20° C. to 80° C., and more preferably about 40° C. to 60° C.

The film in which the photochromic dye is included in the dyeing step is immersed in a crosslinking bath to fix the photochromic dye in the film (a crosslinking step).

As a solution of the crosslinking bath, a crosslinking solution formed by dissolving a crosslinking agent such as boric acid in a solvent is used. As this solvent, for example, water can be used, but an organic solvent compatible with water may be further added to water. As for the concentration of the crosslinking agent in the solution, the crosslinking agent is preferably mixed in the proportion of 2 to 15 parts by mass with respect to 100 parts by mass of a solvent, and more preferably in the proportion of 5 to 12 parts by mass.

A liquid temperature of the crosslinking bath is not particularly limited, but it is preferably about 20° C. to 70° C. An immersing time of the film in the crosslinking bath is not particularly limited, but it is preferably about 60 seconds to 1200 seconds, and more preferably about 200 seconds to 400 seconds.

The above-mentioned hydrophilic polymer film containing the photochromic dye is stretched in a uniaxial direction (a stretching step).

The stretching treatment is preferably performed in any step between the swelling step and the crosslinking step or in two or more steps selected from these steps. Among others, the stretching treatment is preferably performed together with the dyeing treatment and the crosslinking treatment in the dyeing step and the crosslinking step.

Further, the stretching step primarily intended to the stretching treatment may be placed separately between the swelling step and the crosslinking step, or the stretching step primarily intended to the stretching treatment may be placed separately after the crosslinking step.

The draw ratio (if a stretching treatment is performed in two or more steps, it means an overall draw ratio, hereinafter the same) of the hydrophilic polymer film (film before being introduced in the swelling step) is preferably about 2 to 7, that is, a stretched length of the hydrophilic polymer film is about 2 to 7 times longer than an original length, and the draw ratio is more preferably about 3 to 6.

The stretching treatment is preferably performed in a liquid. As this liquid, water, ethanol or the like is appropriately used. A liquid temperature of the stretching bath is preferably about 40° C. to 70° C., and more preferably about 50° C. to 60° C.

The stretched film is immersed in a cleaning bath filled with water (a cleaning step), and then dried, and thereby the polarizer of the present invention can be obtained.

### <Polarizing Plate Including Polarizer>

The polarizer of the present invention can be used singly, but it is generally provided in the form of a polarizing plate in which a protective layer or the like is laminated.

A protective layer is laminated on one side or both sides of the polarizer. As described later, when a retardation plate is laminated on the polarizer, it is preferred that at least the protective layer is provided on the surface (the side opposite to a laminated side of the retardation plate) of the polarizer

Further, as a material of the protective layer, a film having substantially no ultraviolet light absorption power is preferably employed. The reason for this is that if the protective layer has the ultraviolet light absorption power, there is a possibility that ultraviolet light is absorbed by the protective layer and the photochromic dye in the polarizer is not colored.

By the way, the phrase “having substantially no ultraviolet light absorption power” means that a substance (for example, an ultraviolet absorber) intended to absorb or shield the ultraviolet light is not included in the protective layer. Accordingly, even if there are occasions when a resin material composing the protective layer or an additive (additive not intended to absorb ultraviolet light) contained in the protective layer absorbs or shields ultraviolet light slightly, this protective layer is interpreted as having substantially no ultraviolet light absorption power.

The above-mentioned protective layer provided is preferably a film being excellent in transparency, mechanical strength, thermal stability, shielding property against humidity, isotropy and the like. The protective layer include films of a polyester-based polymer such as polyethylene terephthalate or polyethylene naphthalate; cellulose-based polymer such as diacetylcellulose or triacetylcellulose; acrylic-based polymer such as polymethyl methacrylate; styrene-based polymer such as polystyrene or acrylonitrile-styrene copolymer (AS resin); polycarbonate-based polymer and the like.

Also, polymer films of polyolefin-based polymer such as polyethylene, polypropylene, polyolefin having a cyclo-based or norbornene structure, or ethylene-propylene copolymer; vinyl chloride-based polymer; amide-based polymer such as nylon or aromatic polyamide; imide-based polymer; sulfone-based polymer; polyethersulfone-based polymer; polyetheretherketone-based polymer; polyphenylene sulfide-based polymer; vinyl alcohol-based polymer; vinylidene chloride-based polymer; vinyl butyral-based polymer; allylate-based polymer; polyoxymethylene-based polymer; epoxy-based polymer; the blended product of these polymers described above; and the like can be exemplified. The protective layer can also be formed with a cured layer of thermosetting-type or ultraviolet-setting type resin such as acrylic-based, urethane-based, acrylurethane-based, epoxy-based, or silicone-based.

Various additives such as a stabilizer, an antioxidant, an antistatic agent and a plasticizer may be added to the film composing the protective layer as required. However, the reason why it is preferred that an ultraviolet absorber is not added is as described above.

The protective layer is generally stuck to the polarizer through an adhesive. Here, the adhesive includes a material which is referred to as an adhesive agent.

### <Circular Polarizing Filter Including Polarizer>

The polarizer and the above-mentioned polarizing plate of the present invention can be used in the form of an optical film in which at least one species of retardation plates is laminated.

As the above-mentioned retardation plate included in the circular polarizing filter of the present invention, a retardation plate converting linearly polarized light to circularly polarized light is employed.

The retardation plate may be composed of one sheet or may be a multiple layer structure of two or more.

As the retardation plate converting linearly polarized light to circularly polarized light, typically, a quarter-wave plate is used. A material of the quarter-wave plate is not particularly limited, and as the material, for example, a polymer film, a liquid crystal film, and a film in which a liquid crystal material is aligned can be used.

The above-mentioned quarter-wave plate is laminated in such a way that a slow axis direction (direction where a refractive index is largest in a plane) of the quarter-wave plate is at an angle of 45°±5° with respect to an alignment direction of the photochromic dye of the polarizer, and preferably 45°±3°.

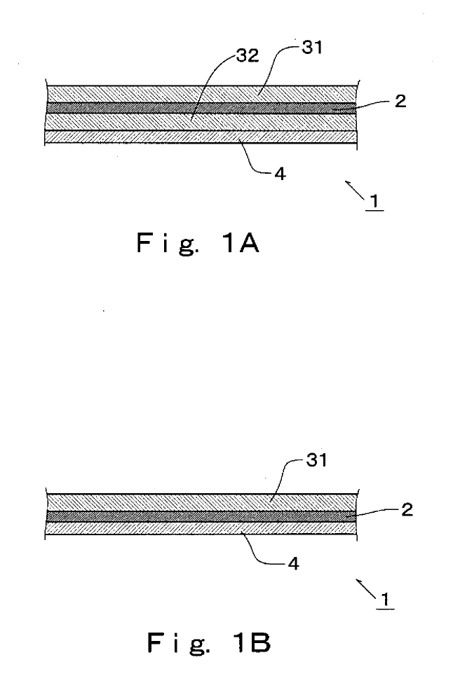

In FIGS. 1A and 1B, a preferred layer constitution of the circular polarizing filter is shown.

In these drawings, a circular polarizing filter 1, a polarizer 2, protective layers 31, 32, and a retardation plate 4 are shown.

FIG. 1A shows a circular polarizing filter 1 in which protective layers 31, 32 are laminated on both sides of a polarizer 2. FIG. 1B shows a circular polarizing filter 1 in which a protective layer 31 is laminated on the surface of the polarizer 2.

The retardation plate 4 is laminated on and bonded to the protective layer 32 or the polarizer 2 through an adhesive (not shown). However, in some species of the retardation plate 4, the retardation plate can also be formed directly on the surface of the protective layer or the polarizer. In this case, the adhesive is unnecessary.

Further, as the protective layer 31 laminated on the surface of the polarizer 2 of the protective layers 31, 32 a protective layer having substantially no ultraviolet light absorption power is preferably used. The reason for this is that as described later, the protective layer 31 is located at the outermost of a screen in a practical use of the circular polarizing filter 1 and therefore it is necessary to prevent the ultraviolet light entered the protective layer 31 from being absorbed by the protective layer 31.

In addition, an adhesive layer is preferably provided on the backside of the circular polarizing filter 1 (backside of the retardation plate 4) to stick the circular polarizing filter 1 to the screen or the like.

### <Image Display System>

The image display system of the present invention includes the above-mentioned polarizer or circular polarizing filter. Preferably, the above circular polarizing filter is provided on the surface of the screen in the image display system of the present invention.

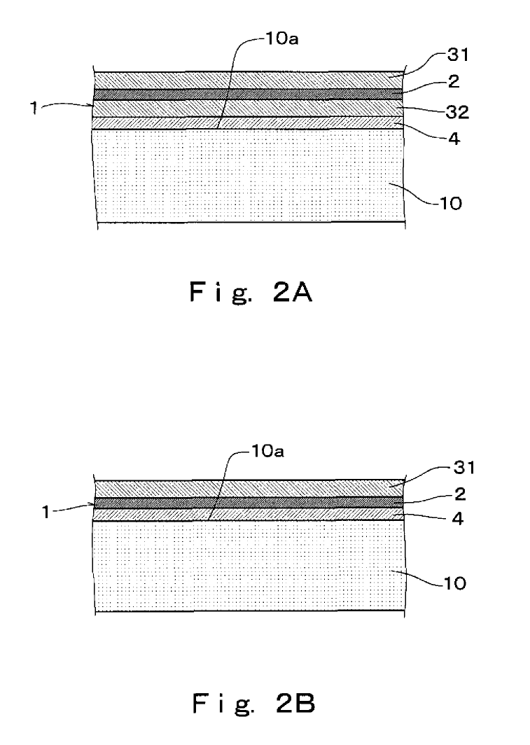

An example of the circular polarizing filter applied to the image display system is shown in FIGS. 2A and 2B.

In these drawings, a reference numeral 10 indicates an image display device of an image display system, and other reference numerals indicate the same components as in FIGS. 1A and 1B.

FIG. 2A shows an example of the configuration in which the circular polarizing filter 1 of FIG. 1A is applied to the image display system. FIG. 2B shows an example of the configuration in which the circular polarizing filter 1 of FIG. 1B is applied to the image display system.

In both Figs, the circular polarizing filter 1 is located with the retardation plate 4 directed toward the screen surface 10a of the image display system 10.

In the circular polarizing filter of the present invention, a polarizer exhibiting dichroism by ultraviolet light irradiation and a retardation plate converting linearly polarized light to circularly polarized light are laminated.

This polarizer changes to a film transmitting linearly polarized light in a certain vibration direction (namely exhibiting a polarization property) by intense ultraviolet irradiation. Therefore, in outdoors etc., when the outside light such as solar light impinges on the surface (i.e., a polarizer) of the circular polarizing filter 1, the polarizer exhibits polarization properties by the intense ultraviolet light included in the outside light. A part of the outside light impinged on the polarizer is absorbed by the polarizer and a part of the light is transmitted through the polarizer as linearly polarized light. The transmitted linearly polarized light is converted to circularly polarized light by a retardation plate and reflected in the system, and then the resulting laterally-reversed circularly polarized light enters the retardation plate again, and converted to linearly polarized light in the direction in which a polarization plane is orthogonal to a direction of a transmission axis of the polarizer. The linearly polarized light cannot transmit through the polarizer since a vibration direction of the linearly polarized light is parallel to a direction of an absorbing axis of the polarizer exhibiting the polarization properties. Therefore, the reduction in the screen visibility resulting from the reflection of the outside light can be prevented.

On the other hand, when an effect of visible light and/or a thermal effect becomes larger than that of ultraviolet light, the polarizer of the present invention is discolored and loses polarization properties. As a result, when the polarizer is placed in an environment of a relatively low ultraviolet light quantity and a large visible light quantity such as an indoor area, the polarizer becomes a film not exhibiting polarization properties. Therefore, the polarizer does not absorb the emitted light for display emitted by the display system itself and transmits it.

Accordingly, in an environment of relatively weak outside light such as an indoor area, the screen of the image display system is displayed brightly. In addition, in the environment of relatively weak outside light, since the problem of reflections of the outside light hardly arises, the reduction in the screen visibility resulting from reflections of the outside light hardly occurs.

The above-mentioned image display system is not particularly limited, and examples of the image display system include self-luminous systems such as an organic EL display system, a liquid crystal display system, a plasma display (PDP), and a field emission display (FED).

Since the circular polarizing filter of the present invention can prevent the reflection of the outside light, it is particularly effectively applied to, for example, the organic EL display system in which the outside light tends to be reflected by a reflective metal plate provided in the display system.

The image display system of the present invention is used for arbitrary use. The image display system of the present invention can be used for, for example, a television, display equipment for a commercial store such as an a monitor for information, a personal computer monitor, a notebook computer, office automation equipment, portable equipment such as a mobile phone, a personal digital assistant (PDA) and a handheld gaming device, a video camera, domestic electric appliances, vehicle-mounted equipment such as a monitor for a car-navigation system and a car-audio system, security equipment such as a surveillance monitor, a nursing care monitor, and a monitor for medical use.

Particularly, the image display system of the present invention is preferably used for applications used both outdoors and indoors such as a television, a notebook computer, portable equipment such as a mobile phone and a handheld gaming device, a video camera, and a monitor for a car-navigation system.

### Example

The present invention will be described in more detail by way of examples. But, the present invention is not limited to only the following Example.

Analytical methods used in this example are as follows.

### (1) Measuring Method of Absorbance of Polarizer:

The absorbance was measured with a spectrophotometer (manufactured by Hitachi, Ltd., trade name: Spectrophotometer Model U-4100).

### (2) Measuring Method of Polarization Degree of Polarizer:

Incident light is brought into a polarized state to measure the transmittance with a spectrophotometer (manufactured by Hitachi, Ltd., trade name: Spectrophotometer Model U-4100), and the polarization degree (P) was determined from the following equation:

P={(k₁k₂)/(k1+k2)}×100,

wherein k₁ is a transmittance in assuming that a polarization plane of the incident light is orthogonal to a stretching direction of the polarizer and k₂ is a transmittance in assuming that the above-mentioned polarization plane is parallel to a stretching direction of the polarizer.

### (3) Measuring Method of Thickness:

The thickness was measured with a digital micrometer “Model KC-351C” manufactured by Anritsu Corp.

### Example

Spiropyran dye expressed by the formula (I) (1,3,3-trimethylindolino-6′-nitrobenzopyrylospiran, produced by Tokyo Chemical Industry Co., Ltd., trade name: T0366) as a photochromic dye and polyvinyl alcohol (polymerization degree: 1700, produced by KURARAY Co., Ltd.) as a transparent resin were dissolved in a DMSO solvent to prepare a mixed solution. A mixing ratio (by mass) of the dye and the PVA of 1:99 was set and the mixed solution was a 12% by mass solution of PVA.

This mixed solution was spread on a polyethylene terephthalate film so as to have a uniform thickness and dried under a reduced pressure to form a PVA film (average thickness 70 μm) containing a dye.

A polarizer was prepared by placing the obtained film in a stretching machine and stretching the film by 5 times in a longitudinal uniaxial direction in an atmosphere of 60° C.

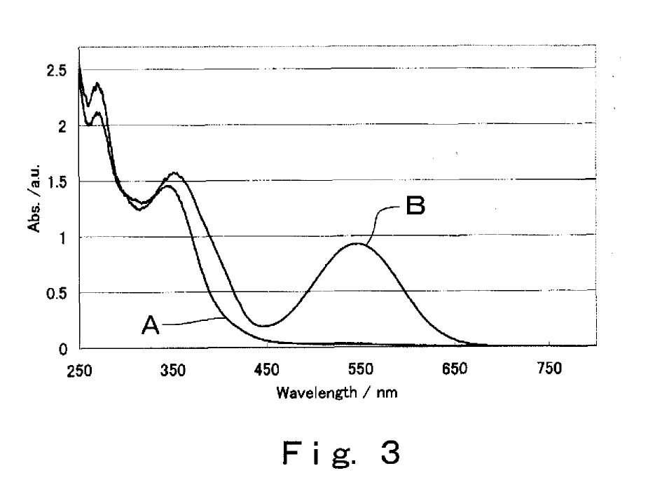

The absorbance of the obtained polarizer was measured, and consequently the results shown in FIG. 3 were obtained (a graph denoted by a symbol A in FIG. 3). This polarizer exhibits little absorption in a visible light region and the absorbance of the polarizer at a wavelength of 548 nm was 0.03.

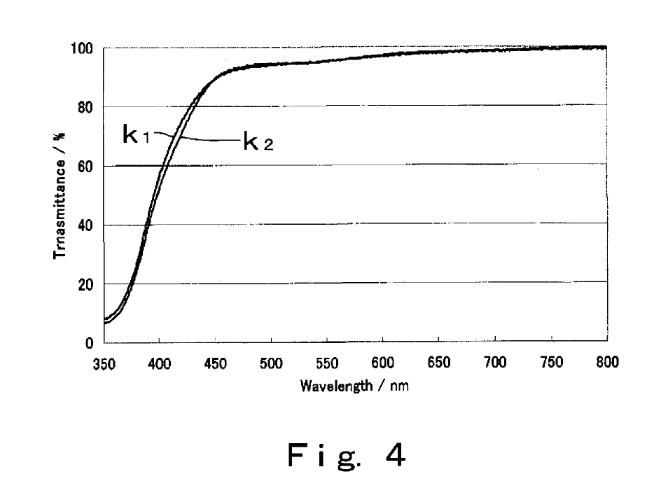

Further, the polarization degree of this polarizer was measured, and consequently the results shown in FIG. 4 were obtained. A k₁ value at a wavelength of 548 nm was 95.1% and a k₂ value at a wavelength of 548 nm was 95.0%, and the polarization degree derived from these results was 0%.

Next, ultraviolet light with a wavelength of 365 nm was irradiated to the above-mentioned polarizer at the intensity of 1.0 mW/cm² using a commercially available ultraviolet lamp. And, the absorbance and the polarization degree of the polarizer immediately after ultraviolet light irradiation were measured. The absorbance was as shown in FIG. 3 (a graph denoted by a symbol B in FIG. 3). The absorbance at the maximum absorption wavelength (548 nm) in the visible light region of the dye was 0.93, and the polarizer showed violet.

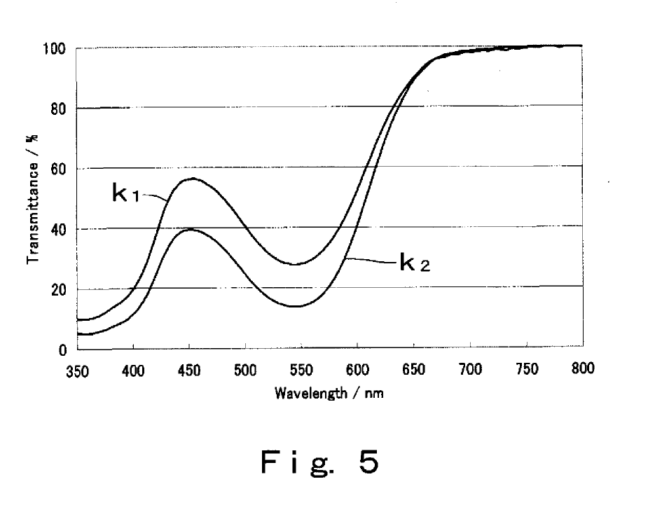

As for the polarization degree of the polarizer after ultraviolet light irradiation, the results shown in FIG. 5 were obtained. A k₁ value at a wavelength of 548 nm was 27.9% and a k₂ at a wavelength of 548 nm value was 13.7%, and the polarization degree derived from these results was 34%.

Change in the molecular structure of the used photochromic dye between before and after ultraviolet light irradiation is shown in the formula (I) below.

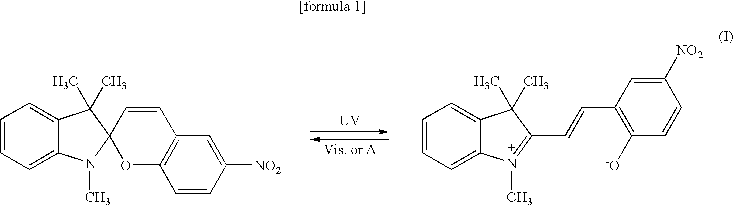

Next, after the above-mentioned ultraviolet light irradiation, the polarizer in a colored state was left standing in a bright place (at 25° C.) in an indoor area illuminated by an ordinary fluorescent lamp, and consequently the polarizer was discolored within 10 minutes and returned to an original state before ultraviolet light irradiation. The absorbance and the polarization degree of the discolored polarizer were measured, and consequently the polarizer showed the same values (absorbance: about 0.03, polarization degree: about 0%) as those of the polarizer before the above-mentioned ultraviolet light irradiation.

Further, an operational procedure in which the above-mentioned polarizer is irradiated with ultraviolet light and left standing was repeated again, the transition between the colored state and the discolored state was repeated corresponding to this.

What is claimed is:

1. A polarizer containing a photochromic dye.

2. The polarizer according to claim 1, wherein the polarizer uses the photochromic dye as a dichroic dye.

3. The polarizer according to claim 1, wherein the photochromic dye is aligned in one direction.

4. The polarizer according to claim 1, wherein the photochromic dye exhibits a photochromic property in which the dye is colored by ultraviolet light irradiation and discolored by visible light irradiation or heat after being colored.

5. The polarizer according to claim 1, wherein the polarizer can be obtained by forming a resin composition containing the photochromic dye and a resin into a film and stretching the film.

6. A polarizing plate in which a protective layer is laminated on one side or both sides of the polarizer according to claim 1.

7. The polarizing plate according to claim 6, wherein the protective layer have substantially no ultraviolet light absorption power.

8. A circular polarizing filter in which at least one species of retardation plates is laminated on the polarizer according to claim 1.

9. The circular polarizing filter according to claim 8 in which a protective layer is laminated on one side or both sides of the polarizer.

10. An image display system, wherein the circular polarizing filter according to claim 8 is provided on an image display surface with the retardation plate of the circular polarizing filter toward the image display surface.

11. The image display system according to claim 10, wherein the image display system is an organic EL display system having an organic EL device.

12. A method of producing a polarizer, wherein a photochromic dye is aligned in one direction by stretching a resin film containing the photochromic dye.

13. The method of producing a polarizer according to claim 12, wherein the resin film containing a photochromic dye is prepared by casting a resin solution formed by dissolving at least a resin and a photochromic dye in an solvent on a substrate.

14. The method of producing a polarizer according to claim 13, wherein the resin film is stretched in a condition of heating.

15. The method of producing a polarizer according to claim 12, wherein the resin film containing a photochromic dye is prepared by swelling a resin film and immersing the swelled film in a solution containing a photochromic dye.

16. The method of producing a polarizer according to claim 15, wherein the resin film is stretched in a liquid.
